(19) United States
(12) Patent Application Publication
(10) Pub. No.: US 2025/0371546 A1
(43) Pub. Date: Dec. 4, 2025

(54) SYSTEMS AND METHODS FOR DETECTING AND RESPONDING TO TRANSACTION THREATS CAUSED BY GEOPOLITICAL EVENTS

(71) Applicant: Wells Fargo Bank, N.A., San Francisco, CA (US)

(72) Inventors: Fernan Banez, San Francisco, CA (US); John Michael Ciccarone, San Francisco, CA (US); Karen Leonard-Albrecht, San Francisco, CA (US); Michael Mangieri, West Islip, NY (US)

(73) Assignee: Wells Fargo Bank, N.A., San Francisco, CA (US)

(21) Appl. No.: 18/678,670

(22) Filed: May 30, 2024

(51) Int. Cl. G06Q 20/40

(52) U.S. Cl. CPC G06Q 20/4016; G06Q 20/4015

(57) ABSTRACT

Systems and methods are described herein for detecting and responding to transaction threats caused by geopolitical events. Such systems and methods may use a provider computing system to receive a transaction request and to receive third-party data from one or more third-party data sources. The provider computing system may identify, using a trained artificial intelligence (AI) model configured to ingest the third-party data, one or more geopolitical events based on the third-party data. The provider computing system may determine, based on the one or more identified geopolitical events, a threat associated with the transaction request and a severity of the threat. In response to the transaction request and based on the severity of the threat, the provider computing system may initiate a remedial action. The remedial action may include denying the transaction request, delaying the transaction request, or requiring a user-verification of the transaction request.

### TECHNICAL FIELD

The present disclosure relates to systems and methods for detecting and responding to transaction threats caused by geopolitical events. More specifically, the present disclosure relates to performing a remedial action with respect to a transaction request that may be adversely impacted by the geopolitical event.

### BACKGROUND

Geopolitical events (e.g., an outbreak of war) pose considerable security threats to transactions associated with any of the parties relating to the geopolitical events. These geopolitical events are often associated with political turmoil, civil unrest, economic instability, financial collapse, and so on. Therefore, transactions that are being sent to and/or received from a party (e.g., a country) associated with a geopolitical event may possess an inherent security risk and may benefit from requiring an additional measure of review and approval.

### SUMMARY

An embodiment relates to a provider computing system. The provider computing system includes a processing circuit having one or more processors coupled to one or more memory devices. The one or more memory devices store instructions thereon that, when executed by the one or more processors, cause the processing circuit to perform operations including: receiving a transaction request including transaction data; receiving third-party data from one or more third-party data sources; identifying, using a trained artificial intelligence (AI) model configured to ingest the third-party data, one or more geopolitical events based on the third-party data; determining, using the trained AI model, a threat associated with the transaction request based on the one or more identified geopolitical events; determining, using the trained AI model, a severity of the threat; and initiating a remedial action in response to the transaction request based on the severity of the threat. The remedial action includes at least one of: denying the transaction request; delaying the transaction request for a period of time; or requiring a user-verification of the transaction request.

Another embodiment relates to a method. The method includes: receiving, by a provider computing system, a transaction request including transaction data; receiving, by the provider computing system, third-party data from one or more third-party data sources; identifying, by the provider computing system using a trained artificial intelligence (AI) model configured to ingest the third-party data, one or more geopolitical events based on the third-party data; determining, by the provider computing system using the trained AI model, a threat associated with the transaction request based on the one or more identified geopolitical events; determining, by the provider computing system using the trained AI model, a severity of the threat; and initiating, by the provider computing system, a remedial action in response to the transaction request based on the severity of the threat. The remedial action includes at least one of: denying the transaction request; delaying the transaction request for a period of time; or requiring a user-verification of the transaction request.

Another embodiment relates to a non-transitory computer-readable medium storing instructions that, when executed by one or more processors of a processing circuit, cause the processing circuit to receive a transaction request including transaction data; receive third-party data from one or more third-party data sources; identify, using a trained artificial intelligence (AI) model configured to ingest the third-party data, one or more geopolitical events based on the third-party data; determine, using the trained AI model, a threat associated with the transaction request based on the one or more identified geopolitical events; determine, using the trained AI model, a severity of the threat; and initiate a remedial action in response to the transaction request based on the severity of the threat. The remedial action includes at least one of: denying the transaction request; delaying the transaction request for a period of time; or requiring a user-verification of the transaction request.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 depicts a block diagram of a system for detecting and responding to transaction threats caused by geopolitical events, according to an example embodiment.

FIG. 2 depicts a block diagram of an AI sub-system of the system of FIG. 1, according to an example embodiment.

FIG. 3 depicts a block diagram of an AI model of the AI sub-system of FIG. 2, according to an example embodiment.

FIG. 4 depicts a method of detecting and responding to transaction threats caused by geopolitical events, according to an example embodiment.

FIGS. 5A-5D depict graphical user interfaces (GUIs) displaying a remedial action initiated in response to detecting a transaction threat caused by a geopolitical event, according to example embodiments.

### DETAILED DESCRIPTION

Referring generally to the figures, systems and methods for detecting and responding to transaction threats caused by geopolitical events are disclosed. The systems and methods disclosed herein use artificial intelligence (AI) to monitor payments in real-time to detect fraud and to ensure that appropriate remedial actions are implemented, as appropriate, when geopolitical events occur. These geopolitical events may be detected using the AI to analyze news articles, social media content, and payment transaction flows. For example, using information received from these sources, the systems and methods described herein may be configured to determine when war has broken out and/or when war is about to break out between countries. In some instances, geopolitical events may be sporadic/spontaneous in nature, making real-time detection of these events critical in order to control damages/risks caused by a sudden onset of the geopolitical event (e.g., an outbreak of war). At the same time, some geopolitical events may be predictable/foreseen based on circumstantial data (e.g., rising tensions between political groups, gradual economic instability, financial insecurity, etc.). For these events that may be foreseen, the systems and methods described herein may prove particularly beneficial for taking preventative action in advance of a catastrophic event (e.g., an outbreak of war).

The implementations described herein address the technical problem by providing enhanced data integration and analysis capabilities, which deliver a particular technical solution that streamlines and refines identification of high-risk transactions threatened by geopolitical events. The systems and methods described herein are implemented to improve how data is synthesized and utilized from various sources that provide information relating to geopolitical events. By integrating data related to geopolitical events, these systems and methods provide proactive remedial actions relating to transactions that may be impacted by the geopolitical events. For example, the implementations can provide an automatic denial, delay, or required user-verification of a transaction identified as being impacted by the geopolitical event. Accordingly, this approach provides a specific technical improvement to various technical problems, including those set forth herein.

The detection of and the response to transaction threats caused by geopolitical events can facilitate the management of an account associated with a user, leveraging data analytics to proactively monitor transactions and account data. By applying machine learning models, the systems and methods can detect patterns and predict outcomes based on a large amount of data inputs, such as transaction histories and third-party data. This can improve threat detection such that models are not only based on past geopolitical events but are continuously updated, trained, and provided to a user to proactively and effectively detect threats caused by unprecedented events. Accordingly, the models trained and implemented herein provide technological improvements over existing business ecosystems by providing real-time, adaptive response mechanisms that tailor remedial strategies based on current data insights. That is, these improvements are realized by implementing real-time data integration and dynamic interpretation, enhancing both the speed and accuracy of remedial actions. For example, lack of real-time data integration is a technical problem in existing technological ecosystems, which is solved by implementing adaptive machine learning models, a technical solution.

In some arrangements, the systems and methods can act as intermediaries that assess real-time transactions to monitor for abnormal and high-risk activity. For example, if a scheduled transaction includes a receiving party associated with an aggressor country, the systems and methods can immediately identify the scheduled transaction and display the high-risk transaction prominently among a plurality of transactions across multiple accounts associated with the user. These models can identify vulnerabilities and security issues in transactions across multiple accounts and can also be configured to display the information from multiple accounts on a single user interface to provider operational efficiency for a controller/manager/owner of the multiple accounts. By analyzing transactional and third-party data, such as news articles and social media outlets, the systems and methods can generate recommendations for remedial actions before or after transactions occur.

The systems and methods described herein may generate new processes for a provider institution (e.g., a bank) to adopt in anticipation of a geopolitical event and/or once a geopolitical event has commenced (e.g., war has broken out). For example, if the system determines that an aggressor country is about to attack another country, the systems and methods may generate a recommendation that the bank hold payments that are being sent/that are scheduled to be sent to the aggressor country. These new processes not only benefits users by preventing alerting users of potential risks associated with the transaction as a result of geopolitical events, but the new processes improve processing power by flagging potentially problematic transactions before they are scheduled to occur (e.g., thereby not processing the transaction and avoiding any additional problems that may arise after attempting to process a transaction involving the aggressor country).

The systems and methods may be configured to automate safeguards when a geopolitical event is detected and/or predicted to occur. For example, when a geopolitical event is detected and/or a prediction of a certain category (e.g., a severity) of geopolitical event exceeds a threshold, the systems and methods described herein may be configured to enact a new rule/process that requires an additional layer of review and approval for any payment that is being sent to a bank and/or to an individual residing in the aggressor country. The additional layer of review and approval may require diverting the payment request to a human (e.g., a customer of the bank, a manager at the bank, etc.) to approve or deny the transaction. Furthermore, as described herein, the additional layer of review may capture all affected payments in a batch for a batch review and approval process so that certain categories and/or payments (e.g., payments having certain characteristics/parameters) are either approved, held, delayed, or canceled.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

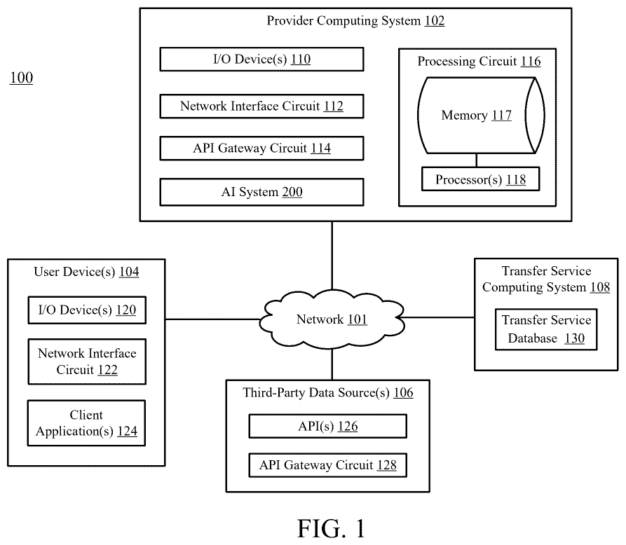

FIG. 1 is a diagram of a system 100 for detecting and responding to transaction threats caused by geopolitical events, according to an example embodiment. As shown, the system 100 includes a provider computing system 102 communicably coupled to one or more user device(s) 104, one or more third-party data source(s) 106, and a transfer service computing system 108. The provider computing system 102 is owned by, associated with, or otherwise operated by a provider (e.g., a bank or other financial institution). The provider may maintain one or more accounts held by various customers, such as demand deposit accounts, credit card accounts, receivables accounts, and so on. The provider computing system 102, the one or more user device(s) 104, the one or more third-party data source(s) 106, and the transfer service computing system 108 are in communication with each other and are connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

In some instances, the provider computing system 102 may be embodied by one or more servers, each with one or more processing circuits (e.g., processing circuit 116) having one or more processors (e.g., processor(s) 118) configured to execute instructions stored in one or more memory devices (e.g., memory 117) to send and receive data stored in the one or more memory devices and perform other operations to implement the methods described herein associated with logic or processes shown in the figures. In some instances, the provider computing system 102 may include and/or have various other devices communicably coupled thereto, such as, for example, desktop or laptop computers (e.g., tablet computers), smartphones, wearable devices (e.g., smartwatches), and/or other suitable devices. For example, an account manager at a financial institution associated with the provider computing system 102 may be configured to access the provider computing system 102 from a laptop computer issued to the account manager by the financial institution. As another example, a user with an account at the financial institution may be configured to access the provider computing system 102 from a smartphone (e.g., via a client application 124) such that the user may receive a notification of a geopolitical event and any transactions threatened by the geopolitical event from any location and at any time. With this portability/accessibility of the services offered by the provider computing system 102, geopolitical events and threatened transactions may be identified and remedial action taken in real-time, therefore mitigating risks caused by geopolitical events.

In some embodiments, the provider computing system 102 includes one or more I/O devices 110, a network interface circuit 112, an API gateway circuit 114, a processing circuit 116, and an AI system 200. The one or more I/O devices 110 are configured to receive inputs from and display information to a user. While the term “I/O” is used, it should be understood that the I/O devices 110 may be input-only devices, output-only devices, and/or a combination of input and output devices.

In some instances, the network interface circuit 112 includes, for example, program logic that connects the provider computing system 102 to the network 101. For example, in some instances, the program logic interfaces with one or more transceivers (e.g., Bluetooth, Wi-Fi, or any other suitable communication transceivers) to enable connection with the network 101. The network interface circuit 112 facilitates secure communications between the provider computing system 102, each of the user device(s) 104, each of the third-party data source(s) 106, and the transfer service computing system 108. The network interface circuit 112 also facilitates communication with other entities, such as other banks or financial institutions, settlement systems, and so on. The network interface circuit 112 further includes user interface program logic configured to generate and present web pages to users accessing the provider computing system 102 over the network 101. For example, the web pages may include identified geopolitical events (e.g., based on data from the third party-data source(s) 106), information relating to the identified geopolitical events, a transaction request impacted by the identified geopolitical event (e.g., received from the user device 104, the transfer service computing system 108, etc.), and a remedial action taken in response to the transaction request impacted by the identified geopolitical event. In some embodiments, the web pages may include GUIs 600a-600d, as described in greater detail herein.

In some embodiments, the provider computing system 102 includes the application programming interface (API) gateway circuit 114. In some embodiments, external devices (e.g., the user device(s) 104, the third-party data source(s) 106, and/or the transfer service computing system 108, etc.) may include and/or execute API protocols that are used to establish an API session between the provider computing system 102 and the external devices. In this regard, the API protocols and/or sessions may allow the provider computing system 102 to communicate content and data (e.g., one or more services offered by the provider computing system 102) to be displayed/provided/rendered directly within the external devices. For example, the external device may activate an API protocol (e.g., via an API call), which may be communicated to the provider computing system 102 via the network 101 and the network interface circuit 112. The API gateway circuit 114 may receive the API call from the network interface circuit 112, and the API gateway circuit 114 may process and respond to the API call by providing API response data. The API response data may be communicated by the provider computing system 102 to the external device via the network interface circuit 112 and the network 101. The external device may then access (e.g., display/use/interface with) the API response data (e.g., one or more services offered by the provider institution) on the external device.

As such, the API gateway circuit 114 is structured to initiate, receive, process, and/or respond to API calls (e.g., via the network interface circuit 112) over the network 101. That is, the API gateway circuit 114 may be configured to facilitate the communication and exchange of content and data between the external devices and the provider computing system 102. Accordingly, to process various API calls, the API gateway circuit 114 may receive, process, and respond to API calls using other circuits. Additionally, the API gateway circuit 114 may be structured to receive communications (e.g., API calls, API response data, etc.) from other circuits. That is, other circuits may communicate content and data to the provider computing system 102 via the API gateway circuit 114. Therefore, the API gateway circuit 114 is communicatively coupled to other circuits of the provider computing system 102, either tangibly via hardware, or indirectly via software.

The provider computing system 102 is shown to include the processing circuit 116, including memory 117 and processor(s) 118. The processing circuit 116 may be structured or configured to execute or implement the instructions, commands, and/or control processes described herein with respect to the memory 117 and/or the processor(s) 118.

The memory 117 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 117 may be or include tangible, non-transient volatile memory or non-volatile memory. The memory 117 may also include database components, object code components, script components, or any other type of information structure for supporting the activities and information structures described in the present application.

The processing circuit 116 is also shown to include processor(s) 118. The processor(s) 118 may be implemented or performed with a general-purpose single- or multi-chip processor, a digital signal processor (DSP), an application specific integrated circuit (ASIC), one or more field programmable gate arrays (FPGAs), or other suitable electronic processing components. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processors 118 may be shared by multiple circuits (e.g., the circuits of the processor(s) 118 may comprise or otherwise share the same processor which, in some example embodiments, may execute instructions stored, or otherwise accessed, via different areas of the memory 117). Alternatively or additionally, the processor(s) 118 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

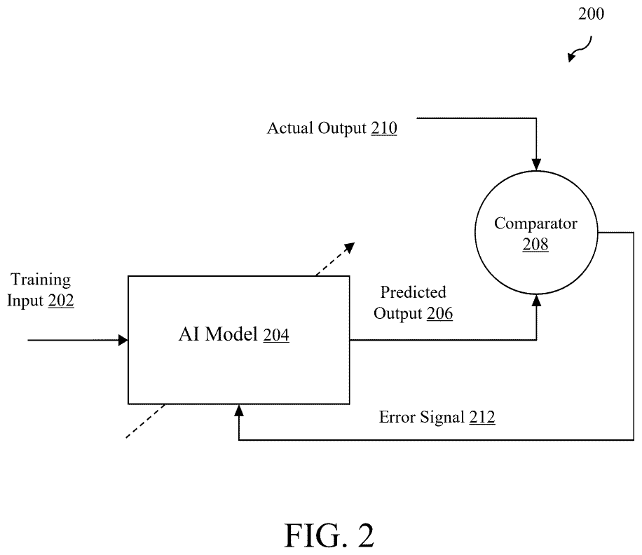

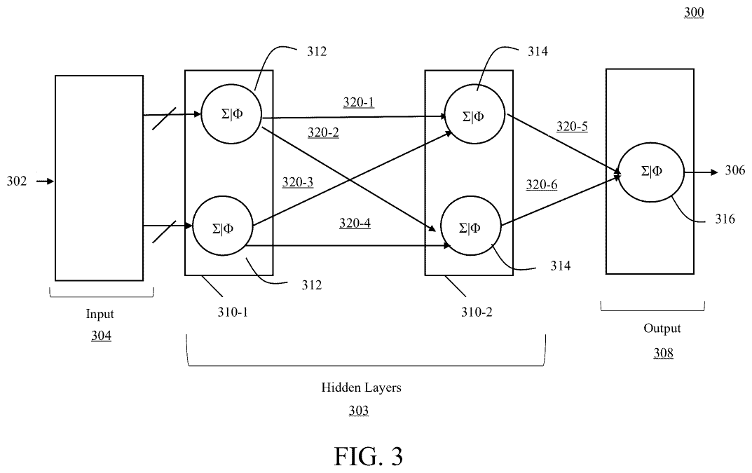

In some embodiments, the provider computing system 102 includes the AI system 200, as described below with reference to FIGS. 2 and 3. Alternatively, the AI system 200 may be remote to the provider computing system 102. For example, in some embodiments, the AI system 200 is separate from the provider computing system 102, and may communicate with the provider computing system 102 via one or more networks, such as the network 101. The AI system 200 may be configured to receive internal data stored by the provider computing system (e.g., from the memory 117). The provider computing system 102 may also be configured to retrieve data from the third-party data source(s) 106 and/or the transfer service computing system 108 (e.g., from the transfer service database 130) to provide to the AI system 200 (e.g., as training inputs 202, as actual outputs 210, etc.). In some embodiments, the AI system 200 receives inputs from the user device(s) 104 via the provider computing system 102 (e.g., received by the network interface circuit 112).

The user device 104 is owned, operated, controlled, managed, and/or otherwise associated with a user, such as an employee of the provider (e.g., a banker, analyst, manager, or other employee that works on managing financial accounts) or a client/customer of the provider (e.g., a person associated with an entity having one or more accounts with the provider). In some embodiments, the user device 104 may be or may include, for example, a desktop or laptop computer (e.g., a tablet computer), a smartphone, a wearable device (e.g., a smartwatch), a personal digital assistant, and/or any other suitable computing device. For example, a user device 104 associated with an account manager at a financial institution may be a laptop computer issued to the account manager by the financial institution. As another example, a user device 104 associated with a customer having an account at the financial institution may be a smartphone, such that the user may receive a notification of a geopolitical event and any transactions threatened by the geopolitical event from any location and at any time. With this portability of the user device 104, the user may receive notifications regarding identified geopolitical events and threatened transactions in real-time, therefore mitigating the risk caused by these geopolitical events.

In some embodiments, the user device 104 includes one or more I/O devices 120, a network interface circuit 122, and one or more client applications 124. While the term “I/O” is used, it should be understood that the I/O devices 120 may be input-only devices, output-only devices, and/or a combination of input and output devices.

In some instances, the I/O devices 120 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.). In some instances, the I/O devices 120 further include one or more user interfaces (devices or components that interface with the user), which may include one or more biometric sensors (such as a fingerprint reader, a face scanner, an iris scanner, etc.).

The network interface circuit 122 includes, for example, program logic and various devices (e.g., transceivers, etc.) that connect the user device 104 to the network 101. For example, in some instances, the program logic interfaces with one or more transceivers (e.g., Bluetooth, Wi-Fi, or any other suitable communication transceivers) to enable connection with the network 101. The network interface circuit 122 facilitates secure communications between the user device 104 and the provider computing system 102. The network interface circuit 122 also facilitates communication with other entities, such as other banks, settlement systems, and so on (e.g., the third-party data sources(s) 106, the transfer service computing system 108, etc.).

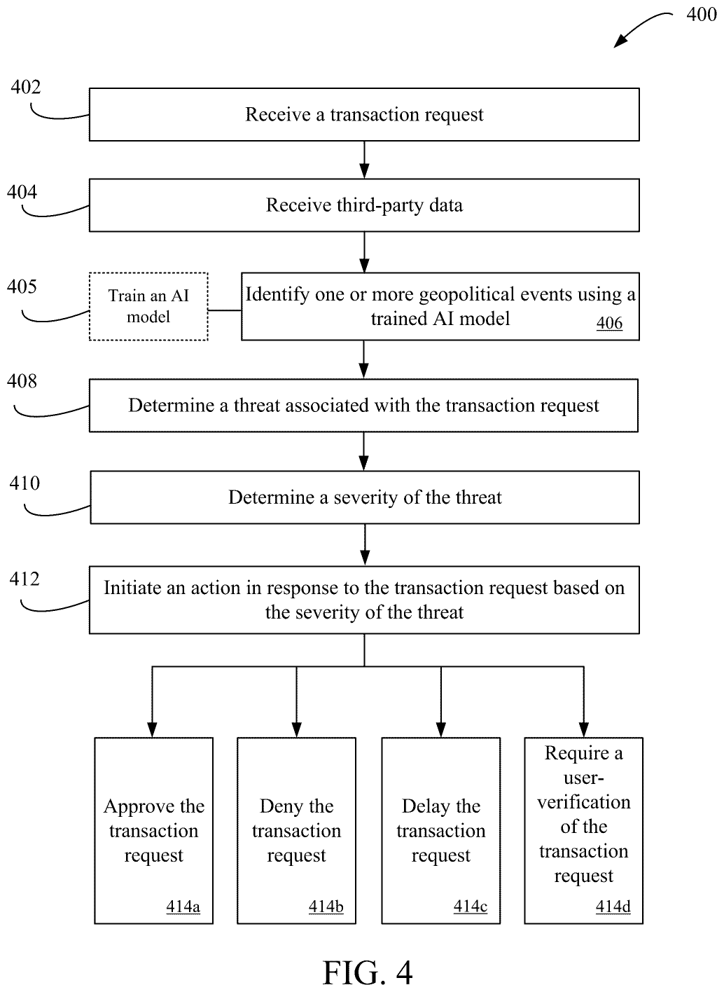

In some embodiments, the user device 104 stores in computer memory, and executes (“runs”) using one or more processors, various client applications 124, such as an Internet browser presenting websites, text messaging applications, and/or applications provided or authorized by entities implementing or administering any of the computing systems in the system 100. For example, in some instances, the client applications 124 include a provider client application (e.g., a financial institution banking application) provided by and at least partly supported by the provider computing system 102. For example, in some instances, the client application 124 coupled to the provider computing system 102 enables the user to perform various activities associated with a transaction (e.g., submit a transaction request, review a transaction request, modify a transaction request, cancel a transaction request, etc.). In some instances, the client application 124 further prompts the AI system 200 to perform various functionalities described herein (e.g., with respect to FIG. 4) to identify a geopolitical event and, in response to a transaction request submitted via the client application 124, a threat to the transaction request caused by the identified geopolitical event.

In some other instances, the client application 124 provided by the provider computing system 102 may additionally be coupled to the transfer service computing system 108 (e.g., via one or more APIs and/or software development kits (SDKs)) to integrate one or more features or services provided by the transfer service computing system 108. For example, in some instances, the provider computing system 102 may integrate a transfer service provided by the transfer service computing system 108 for transferring funds between users of the transfer service using transfer service tokens, as described below, into the client application 124. In some other instances, the transfer service computing system 108 may alternatively provide the transfer service via a separate client application 124.

Accordingly, the client applications 124 are structured to provide the customer with access to various services offered by the provider institution and/or the transfer service. In some embodiments, the client applications 124 are hard coded onto the memory of the user device 104. In some embodiments, the client applications 124 are web-based interface applications, where the customer has to log onto or access the web-based interface before usage, and these applications are supported by a separate computing system comprising one or more servers, processors, network interface circuits, or the like (e.g., the provider computing system 102, the transfer service computing system 108), that transmit the applications for use to the user device 104.

The system 100 is further shown to include one or more third-party data source(s) 106. The third-party data source(s) 106 may provide data to the provider computing system 102, the user device(s) 104, and/or the transfer service computing system 108. In some arrangements, the third-party data source(s) 106 can be structured to collect data from other devices connected via the network 101 (e.g., the user device(s) 104 and/or transfer service computing system 108) and relay the collected data to the provider computing system 102 and/or user device 104. In some embodiments, the third-party data sources(s) 106 may include one or more API(s) 126 and an API gateway circuit 128.

In some embodiments, the third-party data source(s) 106 may include the one or more API(s) 126 communicably coupled to/managed by/or otherwise associated with the third-party data source(s) 106. In some embodiments, the one or more API(s) 126 may be an API associated with one or more programs, services, applications, etc., offered by the third-party data source(s) 106 to one or more users enrolled in such corresponding one or more programs, services, applications, etc. (e.g., a news subscription, a social media platform, etc.).

The third-party data source(s) 106 may include the API gateway circuit 128, which may be similar/identical to the API gateway circuit 114 of the provider computing system 102, as described above. For example, the third-party data source(s) 106 may activate the API protocol, which may be communicated to the provider computing system 102 via the network 101 and the network interface circuit 112.

The system 100 is also shown to include the transfer service computing system 108. The transfer service computing system 108 is controlled by, managed by, owned by, and/or otherwise associated with a transfer service entity (e.g., Zelle®, Billpay, online wire transfer services) that is configured to enable real-time or nearly real-time transfers between users. As described herein and in one embodiment, the “transfer” is a transfer of resources, such as a payment or fund transfer. In some instances, the payment or fund transfer may include electronic or digital fund transfers.

In some instances, the transfer service entity may be provided by a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the system 100. As another example, the transfer service entity may be a third-party vendor. As still another example, the transfer service entity may be provided by the provider institution, such that the provider institution performs both the operations described herein as being performed by the provider computing system 102 and the operations described herein as being performed by the transfer service computing system 108.

In some embodiments, the transfer service computing system 108 may, for example, include one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it may be appreciated that the transfer service computing system 108 may include a network interface circuit, various databases (e.g., similar to the transfer service database 130), an account processing circuit, and other circuits in the same or similar manner to the other components of system 100. In some instances, the network interface circuit may include user interface program logic configured to generate and present application pages, web pages, and/or various other data to users accessing the transfer service computing system 108 over the network 101.

The transfer service computing system 108 is configured to enable real-time or nearly real-time transfers between registered users of the transfer service. For example, in some instances, during a registration process, the transfer service computing system 108 is configured to receive one or more transfer service tokens (e.g., a Zelle® identifier), such as a phone number, an e-mail address, an alphanumeric tag, etc., to be associated with an entity (e.g., the customer or any other user) registering for the transfer service. During the registration process, the transfer service computing system 108 is further configured to receive various account information (e.g., a bank routing number, a bank account number) and identifying information (e.g., a name, a phone number, an e-mail address, a physical address) associated with the entity to be linked to the corresponding received transfer service token(s) for registering the entity with the transfer service.

Accordingly, in some instances, the transfer service computing system 108 is configured to receive a registration request from the provider computing system 102 and/or the user device 104 to register the customer. In some instances, the registration request includes a desired transfer service token, the account information, and the identifying information associated with the customer. Upon receiving the registration request, the transfer service computing system 108 is configured to store the transfer service token, the account information, and the identifying information for the customer within a transfer service database 130 and to link the transfer service token to the account information and the identifying information within the transfer service database 130 to register the customer with the transfer service.

Once the transfer service token, the account information, and the identifying information for the customer have been stored and linked within the transfer service database 130, the transfer service computing system 108 is configured to, upon receipt of a transaction request (e.g., received from the provider computing system 102 or the user device 104), query the transfer service database 130 to retrieve the corresponding account information and identifying information associated with recipient and sender transfer service tokens included in the requested transaction. Once the corresponding account information is successfully retrieved by the transfer service computing system 108, the transfer service computing system 108 is configured to initiate a transfer (e.g., of funds) from an account associated with the sender to an account associated with the recipient. In some embodiments, the transfer service computing system 108 may match a physical address included in the identifying information associated with the recipient and/or the sender transfer service tokens included in the requested transaction with a location of a geopolitical event identified by the provider computing system 102 (e.g., using the AI system 200). In this instance, the transfer service computing system 108 may be configured to initiate a remedial action, as described herein, rather than automatically initiate the transfer indicated by the requested transaction.

As discussed above, the transfer service database 130 stores transfer service tokens, corresponding account information, and corresponding identifying information for various transfer service accounts that are maintained by the transfer service on behalf of its customers. The transfer service database 130 is configured to be used by the transfer service computing system 108 to enable the real-time or near real-time transfers discussed above.

In some instances, the transfer service computing system 108 is configured to provide (e.g., through its own client application or through integration with a client application of another entity, such as client application 124) at least some of the functionality depicted in the figures and described herein. For example, in some instances, as discussed above, at least some of the functionality performed by the transfer service computing system 108 is integrated within a banking application (e.g., one of the client applications 124) provided by the provider computing system 102 to the user device 104. For example, in some instances, the transfer service computing system 108 includes one or more APIs and/or SDKs that securely communicate with the provider computing system 102 (e.g., via the API gateway circuit 114) and allow for various functionality performed by the transfer service computing system 108 to be embedded within the client application 124 provided by the provider computing system 102 to the user device 104.

Referring to FIG. 2, a block diagram of the AI system 200 is shown. The AI system 200 may include at least one AI model 204 (e.g., a machine learning model). In some embodiments, the AI system 200 employs one or more of supervised learning, unsupervised learning, semi-supervised learning, reinforcement learning, self-supervised learning, transfer learning, deep learning, ensemble learning, instance-based learning, decision tree learning, batch learning, or online learning.

In some embodiments, the AI system 200 employs supervised learning, which is a method of training a machine learning model given input-output pairs, where an input-output pair is an input with an associated known output (e.g., an expected output). In some embodiments, the AI system 200 employs unsupervised learning, which is a method of training a machine learning model where the model is presented with unlabeled data and must identify patterns or structures within it using techniques such as clustering or dimensionality reduction. In some embodiments, the AI system 200 employs semi-supervised learning, which is a method of training a machine learning model using a combination of supervised and unsupervised learning where the model is trained on a dataset with both labeled and unlabeled examples. In some embodiments, the AI system 200 employs reinforcement learning, which is a method of training a machine learning model where an agent interacts with data and receives feedback in the form of rewards or penalties and the agent learns to take actions that maximize cumulative rewards over time. In some embodiments, the AI system 200 employs self-supervised learning, which is a method of training a machine learning model where the model generates its own labels from the input data. In some embodiments, the AI system 200 employs transfer learning, which is a method of training a machine learning model which involves training a model on one task and then leveraging the learned features for a different but related task. In some embodiments, the AI system 200 employs deep learning, which is a method of training a machine learning model involving neural networks with multiple layers. In some embodiments, the AI system 200 employs ensemble learning, which is a method of training a machine learning model which involves combining multiple models to improve overall performance and robustness, commonly using techniques such as bagging (e.g., Random Forests) and boosting (e.g., AdaBoost). In some embodiments, the AI system 200 employs instance-based learning, which is a method of training a machine learning model which involves making predictions based on similarities between new instances and instances in the training dataset, commonly using k-Nearest Neighbors (k-NN) algorithms. In some embodiments, the AI system 200 employs decision tree learning, which is a method of training a machine learning model which involves using a tree-like model of decisions and their possible consequences, where each node in the tree represents a decision based on input features. In some embodiments, the AI system 200 employs batch learning, which is a method of training a machine learning model where the model is trained on the entire dataset at once. In some embodiments, the AI system 200 employs online learning, which is a method of training a machine learning model where the model is updated continuously as new data arrives, allowing for real-time adaptation.

The training inputs 202 and the actual outputs 210 may be provided to the AI model 204 as a training dataset. The training dataset refers to data used to train the AI model 204 to identify transaction threats caused by geopolitical events. The training inputs 202 and the actual outputs 210 may be received from one or more data sources of the system 100. The one or more data sources may include one or more internal data sources (e.g., the memory 117) and/or one or more external data sources (e.g., the user device(s) 104, the third-party data source(s) 106, the transfer service database 130, etc.). The one or more internal data sources may be accessible within the provider computing system 102. The one or more external data sources may be accessible over the network 101. For example, the one or more internal data sources may provide account information associated with a user, a transaction history, parameters relating to transactions included in the transaction history (e.g., a timestamp, a transaction type, a transaction amount, or one or more parties associated with the transaction, etc.), and so on. The one or more external data sources may provide news reports, contextual information surrounding geopolitical events, historic data relating to a geopolitical event, government reports, and so on. Thus, the AI model 204 may be trained to identify transaction threats caused by geopolitical events based on the training inputs 202 and the actual outputs 210 used to train the AI model 204.

In some embodiments, the AI model 204 may be trained to make one or more recommendations to the user based on current user data received from at least one of the processing circuit 116, the memory 117, the user device(s) 104, and the third-party data source(s) 106. That is, the AI model 204 may be trained using the training inputs 202, such as the transaction history associated with the one or more accounts associated with the user, to predict outputs 206, such as a threat severity associated with a transaction request affected by a geopolitical event, by applying the current state of the AI model 204 to the training inputs 202. The comparator 208 may compare the predicted outputs 206 to actual outputs 210 (e.g., one or more previous transactions) to determine an amount of error or differences. The actual outputs 210 may be determined based on historic data associated with the recommendation to the user (e.g., data indicating whether the transaction request was affected by the geopolitical event as indicated by the threat severity).

During training, the error (represented by error signal 212) determined by the comparator 208 may be used to adjust the weights in the AI model 204 such that the AI model 204 changes (or learns) over time. The AI model 204 may be trained using a backpropagation algorithm, for instance. The backpropagation algorithm operates by propagating the error signal 212. The error signal 212 may be calculated each iteration, batch and/or epoch, and propagated through the algorithmic weights in the AI model 204 such that the algorithmic weights adapt based on the amount of error. The error is minimized using a loss function. Non-limiting examples of loss functions may include the square error function, the root mean square error function, and/or the cross-entropy error function.

The weighting coefficients of the AI model 204 may be tuned to reduce the amount of error, thereby minimizing the differences between (or otherwise converging) the predicted output 206 and the actual output 210. The AI model 204 may be trained until the error determined at the comparator 208 is within a certain threshold (or a threshold number of batches, epochs, or iterations have been reached). The trained AI model 204 and associated weighting coefficients may subsequently be stored in a memory device or other data repository (e.g., a database) such that the AI model 204 may be employed on unknown data (e.g., not training inputs 202). Once trained and validated, the AI model 204 may be employed during a testing (or an inference phase). During testing, the AI model 204 may ingest unknown data to predict future data (e.g., new threat severities for unprecedented geopolitical events).

Referring to FIG. 3, a block diagram of a simplified neural network model 300 is shown. The neural network model 300 may include a stack of distinct layers (vertically oriented) that transform a variable number of inputs 302 being ingested by an input layer 304, into an output 306 at the output layer 308.

The neural network model 300 may include a number of hidden layers 310 between the input layer 304 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306. Should a user of the system 100 desire a different output, the user can adjust one or more weights to adjust the strength of particular nodes.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

With an example structure of the system 100 being described above, example processes performable by the system 100 (or components/systems thereof) are described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 4, a flow diagram of a method 400 for detecting and responding to transaction threats caused by geopolitical events is shown, according to an example embodiment. In some instances, the method 400 is performed or otherwise executed using various components of the system 100.

As shown, the method 400 begins with the provider computing system 102 receiving a transaction request, at step 402. The provider computing system 102 may receive the transaction request from the user device 104 via the client application 124. The transaction request may be associated with a user account (e.g., a customer account by which the user accesses the client application 124). For example, the user may launch an application session via the client application 124 and may submit the transaction request via a user interface presented on the user device 104. In some embodiments, the transaction request may be retrieved from a scheduled payments log (e.g., stored in the memory 117, the transfer service database 130, etc.). The scheduled payments log refers to a series of pre-staged payments that the provider institution has been instructed (e.g., by a user of the user device, by the transfer service computing system 108, etc.) to execute according to a specific frequency/pattern/regularity. For example, a user may instruct the provider computing system 102 (e.g., via the client application 124) to transfer $100 from a first account to a second account every Friday. As another example, the transfer service computing system 108 may be configured to facilitate a transfer of wages from an account associated with an employer to an account associated with an employee of the employer every other Friday.

In some embodiments, the transaction request refers to an input from a user (e.g., a customer of the provider institution, a user of the transfer service, etc.) prompting the provider computing system 102 and/or the transfer service computing system 108 to facilitate a transaction. The transaction request may refer to a variety of transactions, such as a transfer of funds, an account activation and/or deactivation, a document validation (e.g., a notary service), etc. For example, a transaction represented by the transaction request may include a user (e.g., an investor) paying a recipient (e.g., a financial advisor) in exchange for a service (e.g., financial advising services). In some embodiments, the user can specify transaction data included in the transaction request. The transaction data refers to parameters relating to the transaction represented by the transaction request. For example, the user may indicate parameters, such as a receiving party, a transaction amount, a transaction method, a desired completion date for the transaction, etc. When the provider computing system 102 receives the transaction request via the client application 124, user account information may be associated with the transaction request. In some embodiments, the user account information may specify the transaction data. For example, if a transfer of funds to another account is requested from a user device 104 via the client application 124, a sending party may be specified as the user associated with the user account with which the client application 124 is launched.

As alluded to above, the transaction data refers to one or more parameters characterizing a transaction represented by the transaction request. For example, the transaction data may include at least one of a transaction amount, one or more parties associated with the transaction, a transaction method (e.g., a communication channel, a payment channel, etc.), a desired completion date of the transaction, and so on. The transaction data may be identified by the processing circuit 116 of the provider computing system 102 or by the transfer service computing system 108 (e.g., the transfer service database 130). For example, the processing circuit 116 may identify, from the transaction request, an account number to which a transaction represented by the transaction request requires a transfer of funds. The account number may be identified based on the identified parties to the transaction. In some embodiments, the processing circuit 116 may receive a token representative of the account number associated with the client application 124. The processing circuit 116 may cross-reference the token against a plurality of tokens stored in the memory 117 to verify the account number. From the account number, the processing circuit 116 may identify a user account (e.g., from the memory 117, the transfer service database 130). The processing circuit 116 may then identify the user associated with the identified user account as one of the one or more parties associated with the transaction represented by the transaction request.

The transaction amount refers to a quantity of funds being exchanged as part of the transaction represented by the transaction request. For example, the transaction amount may include an amount of currency (e.g., $5,000, £300, £20, etc.) being paid from one user (e.g., a payer, a sender, etc.) to a second user (e.g., a payee, a recipient, etc.). As a non-monetary example, the transaction amount may refer to one or more documents indicated in the transaction request that require or may require an action, such as a notarization service.

The one or more parties associated with the transaction represented by the transaction request refers to one or more entities involved in the transaction represented by the transaction request. The one or more parties may include one or more users having a customer account at the provider institution. In some embodiments, the one or more parties may include a human being, a business, the provider institution, or any other entity. In some embodiments, the one or more parties may be identified by a customer account from which the transaction request is received (e.g., identified by the processing circuit 116, as described above), or by one or more other entities (e.g., a customer, a business, etc.) designated on the transaction request (e.g., by a name, by an account number, by a routing number, etc.).

The one or more parties associated with the transaction represented by the transaction request may further include at least one of a sending party (e.g., a payer, a provider, etc.) and a receiving party (e.g., a payee, a recipient, etc.). The sending party refers to an entity configured to provide the transaction amount associated with the transaction request. In some embodiments, the sending party is a user with an account at the provider institution. The sending party may be a user associated with the account from which the provider computing system 102 receives the transaction request (e.g., via the client application 124). The receiving party refers to an entity configured to receive the transaction amount associated with the transaction request. In some embodiments, the receiving party is a user with an account at the provider institution. The receiving party may be designated (e.g., by name, by account number, by routing number, etc.) in the first request.

The transaction method refers to a means or methodology by which the transaction represented by the transaction request is performed. The transaction method may include a communication channel, a payment channel, a transfer service, etc., over which the provider computing system 102 conducts or enables the transaction represented by the transaction request. In some embodiments, the transaction method may include a transaction service operated by the transfer service computing system 108. The transaction method may be indicated in the transaction request (as transaction data). In some embodiments, the transaction method may be a preferred transaction method associated with a user account of the user who submits the transaction request. For example, if the provider computing system 102 receives a transfer request from the user device 104 via the client application 124, the client application 124 being accessed through a user account designating Zelle® as a default transfer service, the transfer may be performed using Zelle®.

The desired completion date of the transaction refers to a date on which the transaction represented by the transaction request is to occur. In some embodiments, the transaction request may include a one-time transaction, in which case a user submitting the transaction request (e.g., via the client application 124) may specify the date on which the transaction represented by the transaction request is to be performed. In some embodiments, the transaction request may include a series of scheduled transactions, in which case the user submitting the transaction request (e.g., via the client application 124) may specify a pattern/schedule/frequency according to which the series of scheduled transactions are to be performed. For example, a user may submit a transaction request including a series of six scheduled transactions, and the user may specify the desired completion date of each of the six scheduled transactions as being the first Monday of the month for six months.

Upon receiving the transaction request, at step 402, the provider computing system 102 may be configured to receive third-party data, at step 404. The third-party data refers to data received from one or more data sources that are a third party to the provider institution and to the user (e.g., the third-party data source(s) 106). In some embodiments, the third-party data sources 106 may include social media platforms, new outlets, printed/electronic publications, and so on. The provider computing system 102 may receive the third-party data via an API call (e.g., from the APIs 126 of the third-party data source(s) 106) and using the API gateway circuit 114. The third-party data may include social media posts, news stories, and/or other reports that provide information relating to geopolitical events (e.g., political turmoil, civil unrest, economic instability, financial collapse, and so on).

In some embodiments, the method 400 may include training an AI model at step 405. In some embodiments, the AI model may be the AI model 204, as described above. For example, the AI model may be trained at step 405 using the training inputs 202 and the actual outputs 210 to identify geopolitical events, to determine a threat associated with a transaction request based on the identified geopolitical events, and to determine a severity of the threat.

Upon receiving the transaction request at step 402 and the third-party data at step 404, the provider computing system 102 may be configured to identify one or more geopolitical events using a trained AI model, at step 406. The trained AI model may be configured to ingest third-party data (e.g., the third-party data received at step 404). That is, using the trained AI model, the provider computing system 102 may be configured to identify one or more geopolitical events based on the third-party data.

After identifying the one or more geopolitical events, at step 406, the provider computing system 102 may be configured to determine a threat associated with the transaction request, at step 408. In some embodiments, the trained AI model (e.g., AI model 204) may be configured to determine the threat associated with the transaction request. The threat associated with the transaction request may be determined based on the one or more geopolitical events identified at step 404.

In some embodiments, determining the threat associated with the transaction request comprises identifying, using the trained AI model, at least one common parameter between the transaction data and contextual information related to the one or more geopolitical events. The contextual information refers to information regarding various conditions, circumstances, and so on, surrounding the geopolitical event. The at least one common parameter may include at least one of a geographical location, a currency, one or more parties, a transaction method, or a transaction purpose.

In some embodiments, the provider computing system 102 may be further configured to identify one or more additional transaction requests that include the at least one common parameter. For example, if a geopolitical event involves a declaration of war on a country that is the home country of a receiving party associated with a transaction request, then the provider computing system 102 may be configured to identify one or more additional transaction requests that designate a receiving party where the home country of the receiving party is the country upon which war has been declared. The provider computing system 102 may thereafter generate a batch of affected transactions. The batch of affected transactions refers to a compilation of transaction requests that include the common parameter and are therefore threatened by the identified geopolitical event. The batch of affected transactions includes the transaction request received at step 402 and the one or more identified additional transaction requests.

After determining the threat associated with the transaction request at step 408, the provider computing system 102 may be configured to determine a severity of the threat, at step 410. In some embodiments, the severity of the threat may be determined by the AI model 204. Where the provider computing system 102 has generated a batch of affected transactions, as described above, the severity of the threat determined at step 410 may include a severity applied to the batch of affected transactions.

Based on the severity of the threat determined at step 410, the provider computing system 102 may be configured to initiate an action or a remedial action in response to the transaction request at step 412. The action may include approving the transaction request (e.g., step 414a), and the remedial action may include denying the transaction request (e.g., step 414b), delaying the transaction request (e.g., step 414c), or requiring a user-verification of the transaction request (e.g., 414d). In some embodiments, if the provider computing system 102 has identified a batch of affected transactions, the remedial action initiated at step 412 may be applied to each of the transactions included in the batch of affected transactions.

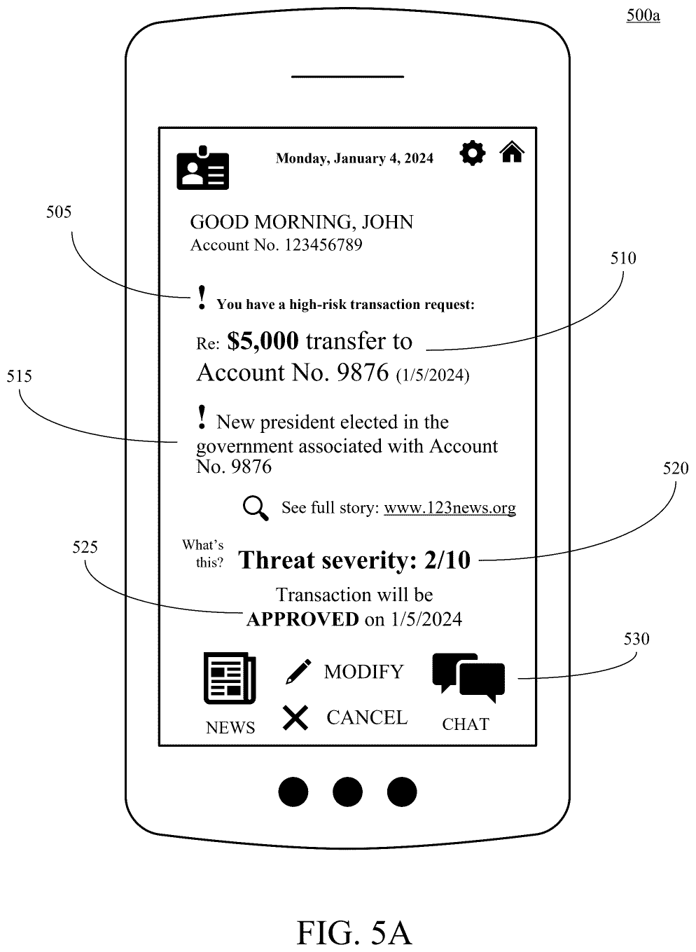

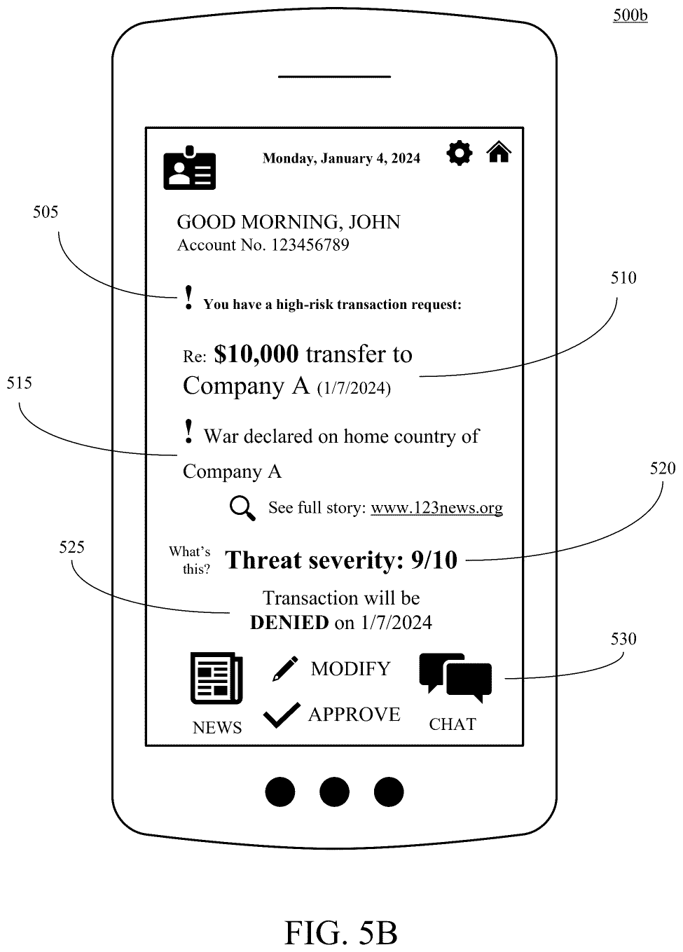

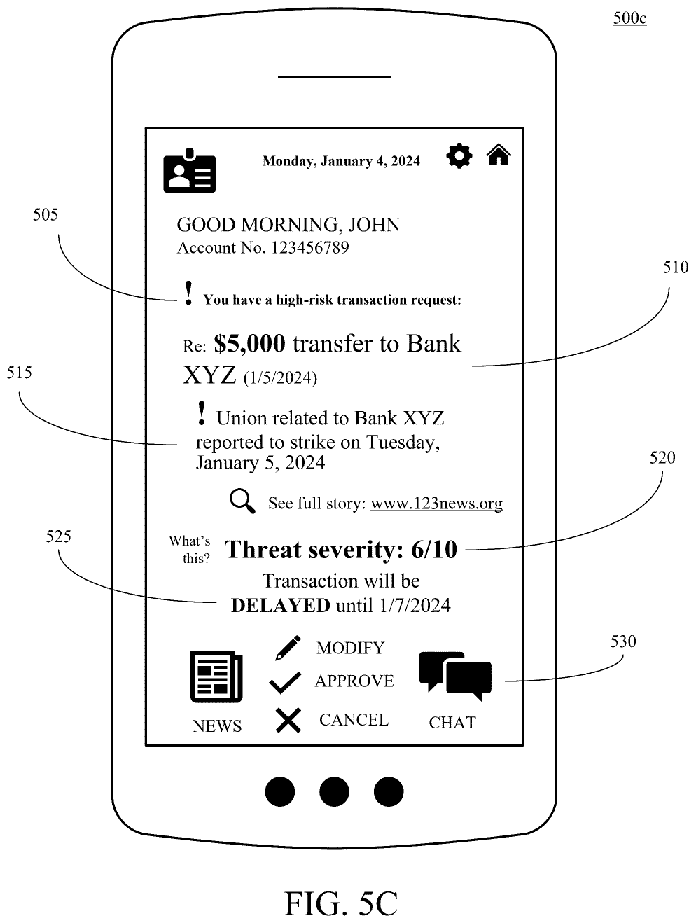

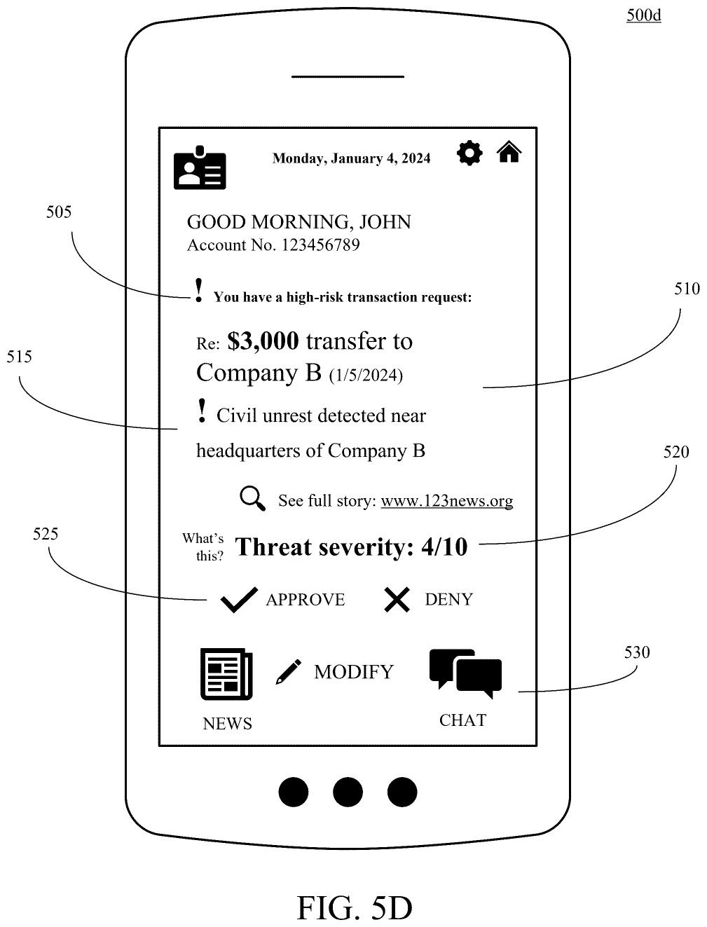

In some embodiments, the remedial action initiated in response to the determined severity of the threat associated with the transaction request may include approving the transaction request at step 414a. For example, FIG. 5A depicts an example graphical user interface (GUI) 500a including an approval of a transaction request based on the severity of a threat to the transaction request. Approving the transaction request may further include processing the transaction represented by the transaction request. In some embodiments, the provider computing system 102 may approve the transaction request if the determined severity of the threat associated with the transaction request does not exceed a predefined threshold. The predefined threshold refers to a security measure that may be implemented by the provider institution and which may require that only transaction requests with an associated threat having a severity below the predefined threshold (e.g., value, limit, level, category, etc.) are approved. In some embodiments, approving the transaction request includes transmitting the transaction request to a transfer service (e.g., to the transfer service computing system 108) for the transfer service to complete a transfer of funds as indicated by the transaction request.

In some embodiments, the remedial action initiated in response to the determined severity of the threat associated with the transaction request may include denying the transaction request at step 414b. For example, FIG. 5b depicts an example GUI 500b including a denial of a transaction request based on the severity of a threat to the transaction request. Denying the transaction request may include failing to process the transaction represented by the transaction request. For example, the provider computing system 102 may deny the first request if the determined severity of the threat associated with the transaction request exceeds the predefined threshold.

In some embodiments, the remedial action initiated in response to the determined severity of the threat associated with the transaction request may include delaying the transaction request at step 414c. For example, FIG. 5C depicts an example GUI 500c including a delay of a transaction request based on the severity of a threat to the transaction request. Delaying the transaction request involves failing to process the transaction represented by the transaction request according to the desired completion date of the transaction as indicated by the transaction data. In some embodiments, the provider computing system 102 may be configured to debit the user's account according to the amount indicated by the transaction request, despite the delay of the transaction request. Alternatively or additionally, the provider computing system 102 may postpone debiting the user's account according to the amount indicated by the transaction request until the transaction represented by the transaction request is processed (e.g., until a passage of the delay).

In some embodiments, delaying the transaction request may include delaying the transaction request for a period of time. The period of time for which the transaction request is delayed may depend on information related to the geopolitical event. For example, if the geopolitical event posing the threat to the transaction request relates to a week-long strike of workers in a particular industry, the period of time for which the transaction request is delayed may correspond to the anticipated duration of the strike (e.g., one week). As another example, the transaction request may be delayed indefinitely until additional third-party data indicates an end to the geopolitical event. That is, if the geopolitical event includes an outbreak of war, the transaction request may be delayed by the provider computing system 102 until the third-party data indicates a ceasefire, a truce, a treaty, or any other indication of an end to the war. In some embodiments, upon determining the delay of the transaction request, the provider computing system 102 may be configured to place the transaction represented by the delayed transaction request in a high-risk queue. That is, the high-risk queue may refer to an ordering of transactions that have been delayed due to a threat to the transaction caused by a geopolitical event. The provider computing system 102 may be configured to update the high-risk queue based on information received from the third-party data sources 106 (e.g., news of the ceasefire, the truce, the treaty, or other indication of the end to the war/geopolitical event), and the provider computing system 102 may be configured to process the delayed transaction requests according to the order of the transactions in the high-risk queue. In some embodiments, the period of time may be determined by the AI model 204 depending on the period of time for which previous transaction requests threatened by geopolitical events of a similar nature have been delayed.

In some embodiments, the remedial action initiated in response to the determined severity of the threat associated with the transaction request may include requiring a user-verification of the transaction request at step 414d. For example, FIG. 5D depicts an example GUI 500d including a requirement of a user-verification of a transaction request based on the severity of a threat to the transaction request. In some embodiments, the user verification may include a prompt for the user to select an approval of the transaction request or a denial of the transaction request. After receiving a response to the prompt, the provider computing system 102 may be configured to approve or deny the transaction request, as described above, depending on the response to the user-verification.

Referring now to FIGS. 5A-5D, multiple GUIs (e.g., GUI 500a, GUI 500b, GUI 500c, GUI 500d) displaying a remedial action initiated in response to detecting a transaction threat caused by a geopolitical event are shown. The multiple GUIs may be configured to be displayed to a user of the user device 104 via the client application 124 during a client application session. The multiple GUIs may be generated and presented to the user of the user device 104 upon identifying a pending transaction request associated with the user that may be threatened by a geopolitical event. Each of the multiple GUIs may include an alert 505, a display of a high-risk transaction request 510, a display of a geopolitical event 515, a display of a threat severity 520, a display of a remedial action 525, and selectable elements 530.

In some embodiments, the alert 505 may be an indication of a high-risk transaction request. For example, the provider computing system 102 may be configured to transmit the alert 505 via one of the multiple GUIs upon determining that a pending transaction request (e.g., the high-risk transaction request indicated by the alert 505) may be adversely affected by a geopolitical event identified by the provider computing system 102. The display of the high-risk transaction request 510 refers to a display of the transaction request indicated by the alert 505 (e.g., the transaction request that may be adversely affected by the identified geopolitical event. In some embodiments, the display of the high-risk transaction request 510 may include a display of the transaction data associated with the high-risk transaction request. For example, as shown in FIGS. 5A-5D, the display of the transaction data may include a transaction amount, one or more parties associated with the transaction request (e.g., a receiving party), a desired completion date of the transaction, and so on.

The multiple GUIs may also include the display of the geopolitical event 515. The display of the geopolitical event 515 may be a display of the geopolitical event identified by the provider computing system 102 (e.g., the one or more geopolitical events identified at step 406 of method 400) based on the third-party data (e.g., the third-party data received at step 404 of method 400). In some embodiments, the display of the geopolitical event 515 may include information surrounding the geopolitical event. For example, the information surrounding the geopolitical event may include one or more parties involved in the geopolitical event, a location of the geopolitical event, a date of the geopolitical event, a nature of the geopolitical event, and so on. In some embodiments, the information surrounding the geopolitical event may further include a relation of the geopolitical event to the high-risk transaction request. The display of the geopolitical event 515 may include a hyperlink configured to, when engaged with/clicked on by a user of the user device 104, display a GUI generated by the third-party data source 106 from which the geopolitical event was identified by the provider computing system 102. The GUI generated by the third-party data source 106 may include a complete story/report/article of the geopolitical event referenced in the display of the geopolitical event 515.

As shown in FIGS. 5A-5D, the multiple GUIs may further include the display of the threat severity 520. The display of the threat severity 520 may include the severity of the threat determined at step 410 of method 400. In some embodiments, the threat severity may be displayed as a value out of a predefined scale (e.g., out of a ten-point scale, out of a five-point scale, and so on). For example, the display of the threat severity 520 may display “Threat Severity: 2/10” to indicate that the high-risk transaction request has a corresponding threat severity caused by the geopolitical event of two out of a ten-point scale. In some embodiments, the GUI may further include an icon configured to provide additional information relating to the threat severity when engaged with/clicked on by a user interacting with the GUI. For example, as shown in FIGS. 5A-5D, the icon may include the hyperlinked text “What's this?” proximate to the display of the threat severity 520. When the user clicks on the hyperlinked text, the provider computing system 102 may be configured to display (e.g., via a separate GUI, a pop-up window, a text box, and so on) additional information relating to how the provider computing system 102 determines the threat severity.

The multiple GUIs may include the display of the remedial action 525. The display of the remedial action 525 may include the remedial action initiated at step 412 of method 400. That is, the remedial action included in the display of the remedial action 525 may be responsive to the transaction request represented by the display of the high-risk transaction request 510 and may be based on the threat severity included in the display of the threat severity 520. In some embodiments, the display of the remedial action 525 may indicate a pending action that the provider institution intends to take in response to the high-risk transaction (e.g., an approval, a denial, a delay, a requirement of a user-verification, etc.). The display of the remedial action 525 may also include a date on which the provider institution intends to perform the pending action.

In some embodiments, the multiple GUIs may also include the selectable elements 530. The selectable elements 530 refer to additional tools/features/actions available to the user via the client application 124. For example, the selectable elements 530 may include an option to initiate a chat feature of the client application 124 (e.g., represented by a chat message icon). With the chat feature, a user of the client application 124 may be connected to a virtual and/or a human agent configured to answer questions/engage in conversation relating to the information displayed via the GUI. The selectable elements 530 may also include an option to modify the transaction request represented by the display of the high-risk transaction request 510. For example, the option to modify the transaction request may allow a user of the client application 124 to update/revise one or more transaction parameters indicated by the transaction data (e.g., a transaction amount, a transaction method, one or more parties associated with the transaction, a desired completion date of the transaction, and so on). The option to modify the transaction request may be advantageous if a user realizes, for example, upon receiving one of the multiple GUIs via the client application 124, that the transaction is identified as a high-risk transaction due to one or more errors in the transaction data. As shown in FIG. 5A and FIG. 5C, in some embodiments, the selectable elements 530 may include an option to cancel the transaction request. The option to cancel the transaction request may be used when a user no longer intends to perform the requested transaction. For example, the threat associated with the transaction may prompt additional concerns for the user with regard to the transaction, and the user may choose to cancel the transaction request entirely. Alternatively or additionally, as shown in FIG. 5B and FIG. 5C, the selectable elements 530 may include an option to approve a transaction that has been automatically denied by the provider institution. For example, the user may have information unavailable to the provider institution (e.g., insider information) that reassures the user of the security of the transaction. In this instance, the user may choose to approve the transaction request despite a determined threat severity associated therewith. In some embodiments, the selectable elements 530 may include a news icon. The news icon may be configured to, once engaged with/clicked on by a user accessing the client application 124, transfer the user (e.g., via a new GUI within the client application 124, a pop-up window, a text box, a webpage, a new GUI of a second application installed on the user device 104, and so on) to a news source. In some embodiments, the new source may be operated/controlled by the third-party data source 106 and accessed from the provider computing system 102 via the API(s) 126.

As shown in FIG. 5A, GUI 500a depicts an approval of a transaction request based on a severity of a threat associated with the transaction request. For example, the transaction request represented by the display of the high-risk transaction request 510 in FIG. 5A includes a $5,000 transfer to Account No. 9876 on Jan. 5, 2024. The display of the geopolitical event 515 indicates that a new president has been elected in the government associated with the Account No. 9876. That is, the provider computing system 102 (e.g., using the AI system 200) may be configured to identify that Account No. 9876 is held at a bank in a country that recently held an election for a new president. Therefore, the recent election of the new president may be identified as a geopolitical event associated with the transaction request. The display of the threat severity 520 may indicate that the severity of the threat to the transaction request posed by the recent presidential election is a two on a ten-point scale (e.g., 2/10). Based on the severity, the GUI 500a may indicate, via the display of the remedial action 525, that the provider computing system 102 is configured to automatically approve the transaction request as indicated by the transaction data (e.g., according to the transaction amount and on the desired date of completion). If, however, the user responsible for submitting the transaction request believes that the recent presidential election may cause unforeseen geopolitical events (e.g., riots, protests, economic collapse, civil unrest, etc.), then the user may use the information and the features included in the GUI 500a to modify and/or cancel the transaction request themselves (e.g., using one of the selectable elements 530).

As shown in FIG. 5B, GUI 500b depicts a denial of a transaction request based on a severity of a threat associated with the transaction request. For example, the transaction request represented by the display of the high-risk transaction request 510 in FIG. 5B includes a $10,000 transfer to Company A on Jan. 7, 2024. The display of the geopolitical event 515 indicates that war has been declared on the home country of Company A. That is, the provider computing system 102 (e.g., using the AI system 200) may be configured to identify that Company A is legally registered in a country upon which war has been declared. Therefore, the declaration of war on the home country of Company A may be identified as a geopolitical event associated with the transaction request. The display of the threat severity 520 may indicate that the severity of the threat to the transaction request posed by the declaration of war is a nine on a ten-point scale (e.g., 9/10). Based on the severity, the GUI 500b may indicate, via the display of the remedial action 525, that the provider computing system 102 is configured to automatically deny the transaction request as indicated by the transaction data (e.g., according to the transaction amount and on the desired date of completion). If, however, the user responsible for submitting the transaction request believes that the declaration of war does not pose a severe threat to the transaction request and if the user wishes to proceed with the transaction request despite the declaration of war, then the user may use the information and the features included in the GUI 500b to modify and/or approve the transaction request themselves (e.g., using one of the selectable elements 530).

As shown in FIG. 5C, GUI 500c depicts a delay of a transaction request based on a severity of a threat associated with the transaction request. For example, the transaction request represented by the display of the high-risk transaction request 510 in FIG. 5C includes a $5,000 transfer to Bank XYZ on Jan. 5, 2024. The display of the geopolitical event 515 indicates that a union related to Bank XYZ has been reported to strike on Tuesday, Jan. 5, 2024. That is, the provider computing system 102 (e.g., using the AI system 200) may be configured to identify that Bank XYZ has employees associated with the union reported to hold an upcoming strike. Therefore, the upcoming strike may be identified as a geopolitical event associated with the transaction request. The display of the threat severity 520 may indicate that the severity of the threat to the transaction request posed by the upcoming strike is a six on a ten-point scale (e.g., 6/10). Based on the severity, the GUI 500c may indicate, via the display of the remedial action 525, that the provider computing system 102 is configured to automatically delay the transaction request until completion of the strike and passage of any immediate repercussions on the following day (e.g., until Jan. 7, 2024). If, however, the user responsible for submitting the transaction request believes that the upcoming strike does not pose a severe threat to the transaction request and if the user wishes to proceed with the transaction request as scheduled (e.g., on Jan. 5, 2024) despite the upcoming strike, then the user may use the information and the features included in the GUI 500c to modify and/or approve the transaction request themselves (e.g., using one of the selectable elements 530). Alternatively or additionally, if the user responsible for submitting the transaction request no longer wishes to proceed with the transaction request at all, then the user may use one of the selectable elements 530 to cancel the transaction request entirely.

As shown in FIG. 5D, GUI 500d depicts a requirement of an additional user-verification of a transaction request based on a severity of a threat associated with the transaction request. For example, the transaction request represented by the display of the high-risk transaction request 510 in FIG. 5D includes a $3,000 transfer to Company B on Jan. 5, 2024. The display of the geopolitical event 515 indicates that civil unrest has been detected near the headquarters of Company B. That is, the provider computing system 102 (e.g., using the AI system 200) may be configured to identify that Company B is headquartered in a city identified by recent news reports as experiencing civil unrest. Therefore, the civil unrest may be identified as a geopolitical event associated with the transaction request. The display of the threat severity 520 may indicate that the severity of the threat to the transaction request posed by the civil unrest is a four on a ten-point scale (e.g., 4/10). Based on the severity, the GUI 500d may indicate, via the display of the remedial action 525, that the provider computing system 102 is configured to require an additional user-verification of the transaction request. As shown in FIG. 5D, the display of the remedial action 525 may include a first selectable element (e.g., “APPROVE”) with which the user may engage to approve the transaction request and a second selectable element (e.g., “DENY”) with which the user may engage to deny/cancel the transaction request. Upon receiving an indication that the user has engaged with the display of the remedial action 525, the provider computing system 102 may be configured to approve or deny the transaction request based on the response to the additional user verification via the GUI 500d.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A provider computing system comprising:
a processing circuit having one or more processors coupled to one or more memory devices storing instructions thereon that, when executed by the one or more processors, cause the processing circuit to perform operations comprising:
receiving a transaction request comprising transaction data;
receiving third-party data from one or more third-party data sources;
identifying, using a trained artificial intelligence (AI) model configured to ingest the third-party data, one or more geopolitical events based on the third-party data;
determining, using the trained AI model, a threat associated with the transaction request based on the one or more identified geopolitical events;
determining, using the trained AI model, a severity of the threat; and
initiating a remedial action in response to the transaction request based on the severity of the threat, wherein the remedial action comprises at least one of:
denying the transaction request;
delaying the transaction request for a period of time; or
requiring a user-verification of the transaction request.

2. The provider computing system of claim 1, wherein determining the threat associated with the transaction request comprises identifying, using the trained AI model, at least one common parameter between the transaction data and contextual information related to the one or more geopolitical events.

3. The provider computing system of claim 2, wherein the at least one common parameter comprises at least one of a geographical location, a currency, one or more parties, a transaction method, or a transaction purpose.

4. The provider computing system of claim 2, wherein the remedial action comprises delaying the transaction request for a period of time, wherein the period of time is a first period of time, and wherein the operations further comprise:
identifying, based on the determined threat associated with the transaction request, one or more additional transaction requests, wherein the one or more additional transaction requests comprise the at least one common parameter;
generating a batch of affected transactions comprising the transaction request and the one or more additional transaction requests; and
at least one of:
approving the batch of affected transactions;
denying the batch of affected transactions;
delaying the batch of affected transactions for a second period of time; or
requiring a user-verification of the batch of affected transactions.

5. The provider computing system of claim 1, wherein identifying the one or more geopolitical events from the third-party data further comprises predicting, using the trained AI model, the one or more geopolitical events based on the third-party data.

6. The provider computing system of claim 1, wherein the operations further comprise:
training, using a training dataset, an AI model;
wherein the training dataset comprises the third-party data.

7. The provider computing system of claim 6, wherein the AI model is a generative AI model, and wherein the training dataset further comprises the determination of the threat associated with the transaction request.

8. The provider computing system of claim 1, wherein the remedial action is determined based on a comparison of the determined severity of the threat associated with the transaction request to a predefined threshold severity scale.

9. The provider computing system of claim 1, wherein the period of time for which the transaction request is delayed is based on the determined severity.

10. The provider computing system of claim 1, wherein the operations further comprise:
generating a display comprising the response to the transaction request; and
presenting the display via a user interface of a user device in real-time relative to receiving the transaction request.

11. A method comprising:
receiving, by a provider computing system, a transaction request comprising transaction data;
receiving, by the provider computing system, third-party data from one or more third-party data sources;
identifying, by the provider computing system using a trained artificial intelligence (AI) model configured to ingest the third-party data, one or more geopolitical events based on the third-party data;
determining, by the provider computing system using the trained AI model, a threat associated with the transaction request based on the one or more identified geopolitical events;
determining, by the provider computing system using the trained AI model, a severity of the threat; and
initiating, by the provider computing system, a remedial action in response to the transaction request based on the severity of the threat, wherein the remedial action comprises at least one of:
denying the transaction request;
delaying the transaction request for a period of time; or
requiring a user-verification of the transaction request.

12. The method of claim 11, wherein determining the threat associated with the transaction request comprises identifying, by the provider computing system using the trained AI model, at least one common parameter between the transaction data and contextual information related to the one or more geopolitical events.

13. The method of claim 12, wherein the at least one common parameter comprises at least one of a geographical location, a currency, one or more parties, a transaction method, or a transaction purpose.

14. The method of claim 12, wherein the remedial action comprises delaying the transaction request for a period of time, wherein the period of time is a first period of time, and wherein the operations further comprise:
identifying, by the provider computing system and based on the determined threat associated with the transaction request, one or more additional transaction requests, wherein the one or more additional transaction requests comprise the at least one common parameter;
generating, by the provider computing system, a batch of affected transactions comprising the transaction request and the one or more additional transaction requests; and
at least one of:
approving, by the provider computing system, the batch of affected transactions;
denying, by the provider computing system, the batch of affected transactions;
delaying, by the provider computing system, the batch of affected transactions for a second period of time; or
requiring, by the provider computing system, a user-verification of the batch of affected transactions.

15. The method of claim 11, wherein identifying the one or more geopolitical events from the third-party data further comprises predicting, using the trained AI model, the one or more geopolitical events based on the third-party data.

16. The method of claim 11, wherein the operations further comprise:
training, by the provider computing system using a training dataset, an AI model;
wherein the training dataset comprises the third-party data.

17. The method of claim 16, wherein the AI model is a generative AI model, and wherein the training dataset further comprises the determination of the threat associated with the transaction request.

18. The method of claim 11, wherein the remedial action is determined based on a comparison of the determined severity of the threat associated with the transaction request to a predefined threshold severity scale.

19. The method of claim 11, wherein the operations further comprise:
generating, by the provider computing system, a display comprising the response to the transaction request; and
presenting, by the provider computing system, the display via a user interface of a user device in real-time relative to receiving the transaction request.

20. A non-transitory computer-readable medium storing instructions that, when executed by one or more processors of a processing circuit, cause the processing circuit to:
receive a transaction request comprising transaction data;
receive third-party data from one or more third-party data sources;
identify, using a trained artificial intelligence (AI) model configured to ingest the third-party data, one or more geopolitical events based on the third-party data;
determine, using the trained AI model, a threat associated with the transaction request based on the one or more identified geopolitical events;
determine, using the trained AI model, a severity of the threat; and
initiate a remedial action in response to the transaction request based on the severity of the threat, wherein the remedial action comprises at least one of:
denying the transaction request;
delaying the transaction request for a period of time; or
requiring a user-verification of the transaction request.
